(19) United States
(12) Patent Application Publication
(10) Pub. No.: US 2013/0124893 A1
(43) Pub. Date: May 16, 2013

(54) IMAGE PROCESSING APPARATUS AND IMAGE PROCESSING METHOD

(71) Applicant: Shuji KAWAKATSU, Kyoto-shi (JP)

(72) Inventor: Shuji KAWAKATSU, Kyoto-shi (JP)

(73) Assignee: MURATA MACHINERY, LTD., Kyoto-shi (JP)

(21) Appl. No.: 13/469,107

(22) Filed: May 11, 2012

(30) Foreign Application Priority Data
Jul. 4, 2011 (JP) 2011-148473

(51) Int. Cl. G06F 1/32

(52) U.S. Cl. CPC G06F 1/3203
USPC 713/323

(57) ABSTRACT

An image processing apparatus includes a network control unit, a main control unit, a clock circuit unit, a sub control unit, and a power mode switching unit. The main control unit transmits transition information to the sub control unit during a transition to a first power saving mode when power supply to the main control unit is stopped. The clock circuit unit transmits a transition instruction to the sub control unit at a specified time. When detecting the transition instruction during the first power saving mode, the sub control unit selectively controls the power mode switching unit to switch a power mode based on the transition information between transition from the first power saving mode to the normal mode and transition from the first power saving mode to the second power saving mode when power supply to the main control unit and the network control unit is stopped.

### CROSS-REFERENCE TO RELATED APPLICATIONS

This application claims priority under 35 U.S.C. 119 to Japanese Patent Application No. 2011-148473, filed on Jul. 4, 2011, which application is hereby incorporated by reference in its entirety.

### BACKGROUND OF THE INVENTION

1. Field of the Invention

The present invention relates to an image processing apparatus including a power-saving mode and an image processing method.

2. Description of the Related Art

An image processing apparatus including a power-saving mode to reduce power consumption on standby has been known. As an example of such an image processing apparatus, there is a system including a main central processing unit (main CPU) and a subordinate central processing unit (sub CPU). With such a system, in a power-saving mode, while the main CPU operates in the power-saving mode or power supply to the main CPU is stopped, power is continually supplied to the sub CPU whose energy consumption is less than the main CPU. In the power-saving mode, the sub CPU is on standby while monitoring an operational status to find a factor for recovery from the power-saving mode.

Further, an information processing system including a network function generally uses a network CPU exclusively for network processing. The network CPU needs to be a high performance CPU, and generally power consumption thereby is more likely to be high. Therefore, in a power-saving mode, a power mode of the CPU is transferred to STANDBY mode, or power supply to the CPU is stopped. Further, packet processing on a network for the information processing system in a power-saving mode is carried out with a subordinate network CPU whose energy consumption is less than the network CPU, or an equivalent device.

Factors for recovery from a power-saving mode to a normal power mode include reception of a packet from a particular network or a facsimile, key operation, input of a programmed job or the like. The programmed job is a reserved operation, for example, which has been previously set so that a facsimile will be sent at a specified time. As performance of many conventional sub CPUs is low, it is likely to difficult to execute a programmed job at the specified time with a single sub CPU. Therefore, in order to execute the programmed job at the specified time even in a power-saving mode, a real time clock (RTC) including a timer function may be used.

As examples of prior art, network devices in which a network (physical layer, PHY) is turned off in a power-saving mode (a state in which power is being saved) have been known. When a data-collection start time arrives, the RTC outputs an interrupt signal to a power-saving controller. After the interrupt signal is input to the power-saving controller, the network (PHY) is turned on.

As described above, in order to monitor an operational status to find a recovery factor in a power-saving mode, it is required to supply power to at least a sub CPU and a sub network CPU. However, during a period of time when a network is hardly used (e.g., holidays or night time), processing of a network packet is hardly executed. Therefore, it can be said that power supply to the sub network CPU working in a power-saving mode during these periods of time is useless.

### SUMMARY OF THE INVENTION

In view of the above-described problems, preferred embodiments of the present invention provide an image processing apparatus that is capable of switching a power mode at an appropriate timing and providing user convenience and power saving effects.

An image processing apparatus in accordance with a preferred embodiment of the present invention includes a network control unit, a main control unit, a clock circuit unit, a sub control unit and a power mode switching unit. The network control unit is connected to a network. The main control unit controls the network control unit. The clock circuit unit stores information on a specified time which has been previously set and measures time. The clock circuit unit also compares the information stored therein to the time measured thereby, and outputs a transition instruction which is a trigger for mode transition based on the time comparison. The sub control unit stores transition information on a power mode to be transferred next, and detects the transition instruction input from the clock circuit unit. The power mode switching unit switches a power mode from/to first power saving mode, in which power supply to the main control unit is stopped, to/from second power saving mode, in which power supply to the main control unit and the network control unit is stopped. At the time of transition to the first power saving mode, the main control unit transmits the transition information to the sub control unit. When determining, based on the time comparison, that the specified time has arrived, the clock circuit unit transmits the transition instruction to the sub control unit. When detecting the transition instruction during the first power saving mode, the sub control unit selectively controls the power mode switching unit to switch the power mode, according to the transition information, from the first power saving mode to a normal power mode or from the first power saving mode to the second power saving mode.

According to the above-described preferred embodiment of the present invention, a period of time (e.g., holidays or night time) that network communication is not carried out has been previously set. Thus, when the specified time arrives, the power mode is transferred from the first power saving mode to the second power saving mode whose power consumption is less than in the first power saving mode. In the second power saving mode, power consumption can be reduced by turning off electricity to the network control unit.

It is preferred that if a programmed job whose execution time is specified has been set, the main control unit sets information on transition to the normal mode to the sub control unit, and also sets information on the specified time for a programmed job to the clock circuit unit. It is also preferred that if a programmed job whose execution time is specified has not been set, the main control unit sets information on transition to the second power saving mode to the sub control unit, and then sets the information on transaction to the second power saving mode to the clock circuit unit.

It is also preferred that the image processing apparatus in accordance with a preferred embodiment of the present invention includes a facsimile communication unit that detects a facsimile ringing signal, wherein power is supplied thereto in either of the first power saving mode or the second power saving mode, and if a facsimile ringing signal detected by the facsimile communication unit is input to the sub control unit, the sub control unit returns the power mode of the main control unit to normal mode.

It is also preferred that the image processing apparatus in accordance with a preferred embodiment of the present invention includes a key operation unit arranged such that power is supplied thereto in either of the first power saving mode or the second power saving mode, wherein the sub control unit returns the power mode of the main control unit to normal mode when a key operation signal is input by a user thereto.

According to the above-described preferred embodiments of the present invention, when a programmed job (e.g., sending a facsimile at a specified time) has been set, a power mode will be transferred to the normal mode when the specified time arrives, which allows the image processing apparatus to execute the programmed job. Further, when a facsimile ringing signal is received or a key operation is performed by the key operation unit, the power mode can be returned to the normal mode from the first power saving mode or the second power saving mode.

Preferred embodiments of the present invention can be realized not only as the above-described image processing apparatuses, but also as a method for performing each operation of characteristic processing sections provided in the image processing apparatuses. A preferred embodiment of the present invention can be also realized as an integrated circuit that performs the operations of each processing section. Also, a preferred embodiment of the present invention can be also realized as a program for executing each step described above on a computer. Such a program can be loaded in storage media, such as a CD-ROM and the like, or via transmission media, such as the Internet.

The image processing apparatus according to various preferred embodiments of the present invention can shift a power mode to the second power saving mode whose power consumption is less than in the first power saving mode when a previously set time arrives, which results in reduction in power consumption.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is one example of a structure of an information processing system including an image processing apparatus in accordance with a preferred embodiment of the present invention.

FIG. 2 is a block diagram illustrating a hardware structure of a network multifunctional peripheral in accordance with a preferred embodiment of the present invention.

FIG. 3 is a block diagram illustrating a functional structure of the image processing apparatus in accordance with a preferred embodiment of the present invention.

FIG. 4 is a flow chart indicating power mode transition processing of the image processing apparatus in accordance with a preferred embodiment of the present invention.

### DETAILED DESCRIPTION OF THE PREFERRED EMBODIMENTS

Preferred embodiments of the present invention will be specifically described with reference to the drawings.

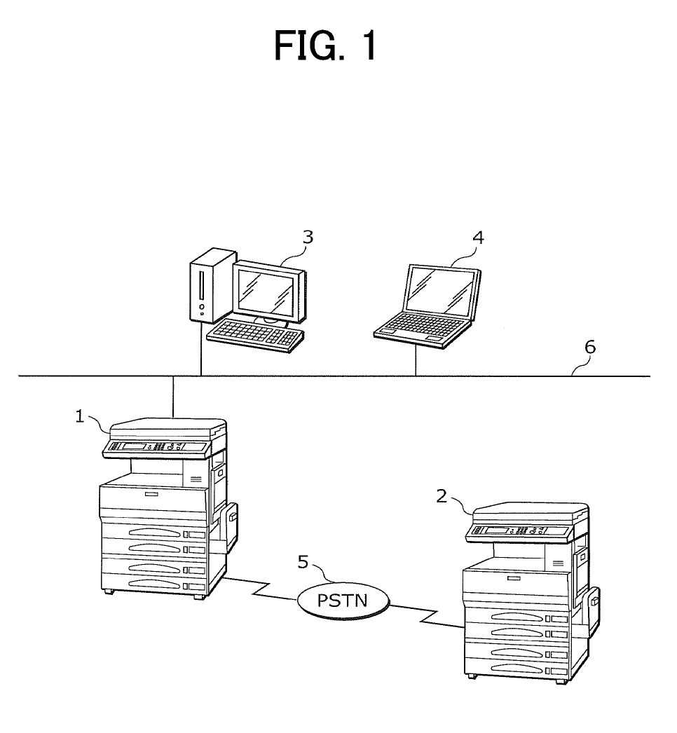

First, with reference to FIG. 1, an outline of an image processing apparatus in accordance with a preferred embodiment of the present invention will be described.

FIG. 1 is one example of a structure of an information processing system including an image processing apparatus in accordance with a preferred embodiment of the present invention.

As illustrated in FIG. 1, the information processing system is configured with network multifunctional peripherals 1 and 2, information terminals 3 and 4, a public switched telephone network (PSTN) 5 and a local area network (LAN) 6.

The information terminals 3 and 4 preferably are computers that function as an information processing device according to a preferred embodiment of the present invention. In the preferred embodiments of the present invention, the information terminals 3 and 4 preferably are personal computers used by operators who use the network multifunction peripheral 1 and 2.

The network multifunctional peripheral 1 functions as an image processing apparatus 100 according to a preferred embodiment of the present invention. The network multifunctional peripheral 1, for example, is capable of performing the following: sending a document scanned by a scanner as a facsimile to the network multifunctional peripheral 2 via the PSTN 5, sending the document to the information terminals 3 and 4 via the LAN 6, or printing out the document with a built-in printer.

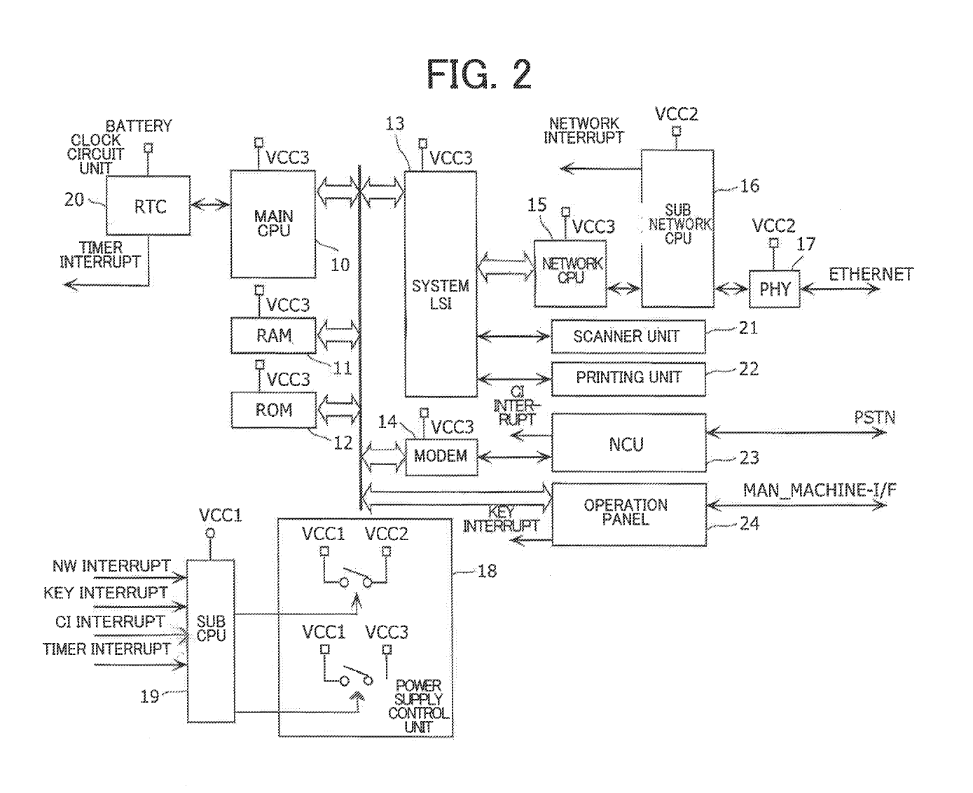

FIG. 2 is a block diagram illustrating a hardware structure of the network multifunctional peripheral 1 in accordance with a preferred embodiment of the present invention.

As illustrated in FIG. 2, the network multifunctional peripheral 1 includes a main central processing unit (main CPU) 10, a random access memory (RAM) 11, a read only memory (ROM) 12, a system large scale integration (system LSI) 13, a modem 14, a network CPU 15, a sub-network CPU 16, a physical layer (PHY) 17, a power-supply control unit 18, a sub-CPU 19, a real time clock (RTC) 20, a scanner unit 21, a printing unit 22, a network control unit (NCU) 23 and an operation panel 24.

The main CPU 10 controls the overall network multifunctional peripheral 1 by executing a control program stored in the ROM 12.

The RAM 11 is a readable and writable memory that stores operational data used by the main CPU 10 to execute the control program and image data obtained from the scanner unit 21, and other data.

The ROM 12 is a read-only memory that stores the control program executed by the main CPU 10.

The system LSI 13 controls transmission and reception of data between the main CPU 10, the RAM 11, the ROM 12 and the network CPU 15, the scanner unit 21, the printing unit 22.

The modem 14 modulates an image data signal or the like stored in the RAM 11 to a facsimile signal and transmits the signal, and demodulates a facsimile signal received from an external device to a line data signal. The modem 14 preferably is, for example, a facsimile modem meeting the G3 standard.

The network CPU 15 is connected to a network interface (network I/F) such as a LAN I/F, and is a CPU which mainly processes a packet from a network.

The sub-network CPU 16 is a CPU whose power consumption is less than the network CPU, and executes a packet processing from a network in a power-saving state.

In the preferred embodiments of the present invention, the PHY 17 is an Ethernet™ LAN I/F, and is a communication adapter connecting the network multifunctional peripheral 1 to the LAN 6.

The power supply control unit 18 turns on/off electricity to each device/unit under the control of the sub-CPU 19. The power supply control unit 18 switches a power mode among OFF mode, SLEEP mode and NORMAL mode based on an instruction given by the sub CPU 19. OFF mode is a power mode in which power from a V_{cc1} power supply terminal is supplied to only the sub CPU 19. In OFF mode, power is not supplied to the sub-network CPU 16, the PHY 17, the main CPU 10, the RAM 11, the ROM 12, the system LSI 13, the modem 14 and the network CPU 15. SLEEP mode is a power mode in which power is supplied to the sub-network CPU 16 and the PHY 17 as well as the sub CPU 19 by connecting the a V_{cc2} power supply terminal to the V_{cc1} power supply terminal. In SLEEP mode, power is not supplied to the main CPU 10, the RAM 11, the ROM 12, the system LSI 13, the modem 14, and the network CPU 15. NORMAL mode is a power mode in which power is supplied to the main CPU 10, the Ram 11, the ROM 12, the system LSI 13, the modem 14, the network CPU 15 as well as the sub CPU 19, the sub network CPU 16 and the PHY 17 by connecting a V_{cc3} power supply terminal to the V_{cc1} power supply terminal in addition to the terminal connection in SLEEP mode. Note that SLEEP mode is a first power saving mode, and OFF mode is a second power saving mode whose power consumption is less than in SLEEP mode.

The sub CPU 19 provides an instruction to the power supply control unit 18 to perform the overall control of power supply to the apparatus. That is, the sub CPU 19 directs the power supply control unit 18 to switch a power mode. This power supply control function will be specifically described later.

The RTC 20 stores the time which has been previously set (hereinafter referred to “setting time”) and measures time. When the setting time arrives, the RTC 20 transmits a timer interrupt signal to the sub CPU 19.

The scanner 21 is an image scanning device, and generates image data by optically scanning an original document with a charge-coupled device (CCD) under the control of the main CPU 10.

The printing unit 22 is a printing device, and prints out image data stored, for example, in the RAM 11, under the control of the main CPU 10.

The NCU 23 is a network control device that controls connection between the modem 14 and the PSTN 5.

The operation panel 24 is a touch panel arranged to receive an instruction provided by a user. Further, the operation panel 24 includes a display device that displays an operation guide for users, or an operation status of the network multifunctional peripheral 1. The operation panel 24 is, for example, a liquid crystal display.

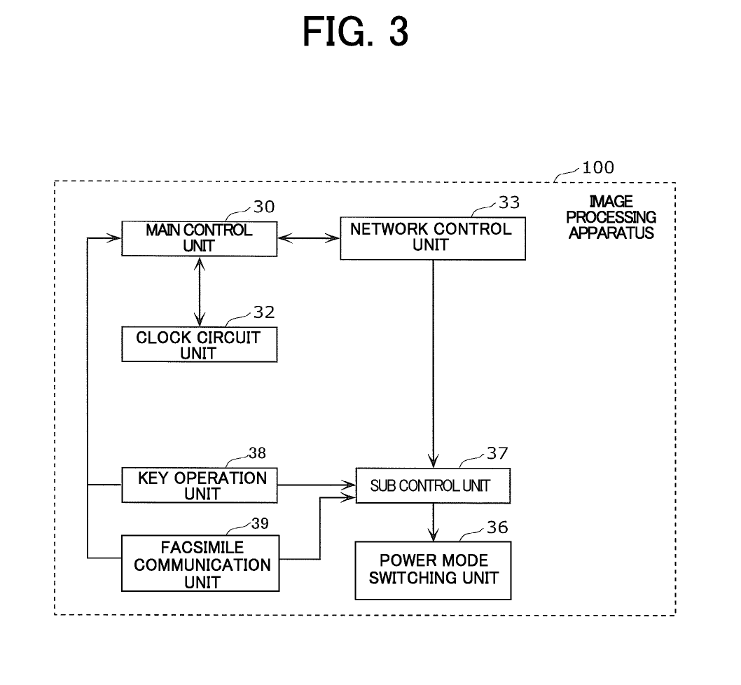

FIG. 3 is a block diagram illustrating a functional structure of the image processing apparatus 100 in accordance with a preferred embodiment of the present invention. Among functions of the network multifunctional peripheral 1 achieved by the hardware structure illustrated in FIG. 2, functions relating to power mode transition processing according to a preferred embodiment of the present invention are illustrated in FIG. 3 as a block diagram.

The image processing apparatus 100 is functionally structured with a main control unit 10, a clock circuit unit 32, a network control unit 33, a power mode switching unit 36, a sub control unit 37, a key operation unit 38, and a facsimile communication unit 39.

The main control unit 30 is a processing unit implemented by the main CPU 10, the RAM 11, the ROM 12, the system LSI 13 and the like illustrated in FIG. 2. The main control unit 30 controls the network control unit 33. Further, at the time of transition to first power saving mode (SLEEP mode), the main control unit 30 transmits information on a power mode to be transferred next (NORMAL or second power saving mode) to the sub control unit 37.

The clock circuit unit 32 is a processing unit implemented by the RTC 20 illustrated in FIG. 2. The clock circuit unit 32 stores information on setting time, and measures time. By comparing the setting time stored therein and the time measured thereby, the clock circuit unit 32 outputs a transition instruction, which is a trigger for mode transition, to the sub control unit 37 based on the time comparison. More specifically, when the clock circuit unit 37 determines, based on the time comparison, that the setting time has arrived, the clock circuit unit 32 transmits a transition instruction to the sub control unit 37.

The network control unit 33 is a processing unit implemented by the network CPU 15, the sub-network CPU 16, the PHY 17 or the like illustrated in FIG. 2. The network control unit 33 is connected to a network (LAN 6) and transmits/receives data via a network with an external device.

The power mode switching unit 36 is a processing unit implemented by the power supply control unit 18 illustrated in FIG. 2. The power mode switching unit 36 switches a power mode between the first power saving mode (SLEEP mode) in which power supply to the main control unit 30 is stopped and the second power saving mode (OFF mode) in which power supply to the main control unit 30 and the network control unit 33 is stopped. As described above, in the first power saving mode, although power supply to some portions of the network control unit 33 (e.g., network CPU 15) is stopped, power is supplied to other portions of the network control unit 33 (e.g., sub-network CPU 16 and the PHY 17).

The sub control unit 37 is a processing unit implemented by the sub CPU 19 or the like illustrated in FIG. 2. The sub control unit 37 stores transition information on a power mode to be transferred next, and detects a transition instruction input from the clock circuit unit 32. When detecting the transition instruction input from the clock circuit unit 32 while in the first power saving mode (SLEEP mode), the sub control unit 37 selectively controls the power mode according to the transition information between transition to the NORMAL mode and transition to the second power saving mode (OFF mode).

The key operation unit 38 is a processing unit implemented by the operation panel 24 illustrated in FIG. 2. Power is supplied to the key operation unit 38 in either of the first power saving mode (SLEEP mode) or the second power saving mode (OFF mode). When a key operation signal is input with the key operation unit 38 to the sub control unit 37, the sub control unit 37 returns the power mode of the main control unit 30 to NORMAL mode.

The facsimile communication unit 39 is a processing unit implemented by the modem 14 and the NCU 23 or the like illustrated in FIG. 2. The facsimile communication unit 39 detects a facsimile ringing signal. Power is supplied to the facsimile communication unit 39 in either of the first power saving mode (SLEEP mode) or the second power saving mode (OFF mode). If the facsimile ringing signal detected by the facsimile communication unit 39 is input to the sub control unit 37, the sub control unit 37 returns the power mode of the main control unit 30 to NORMAL mode.

Next, it will be described with regard to mode transition processing of the image processing apparatus 100 according to a preferred embodiment of the present invention, which is structured as described above.

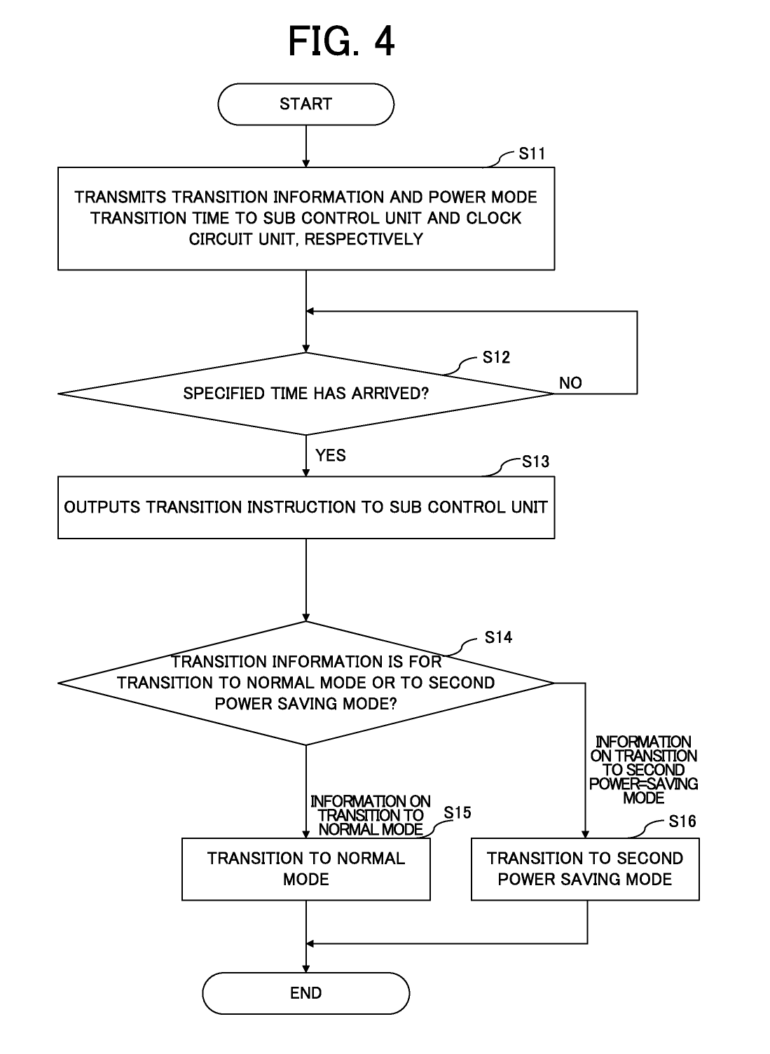

FIG. 4 is a flow chart indicating mode transition processing of the image processing apparatus 100 in accordance with a preferred embodiment of the present invention. As the mode transition processing, only the transition to SLEEP mode (first power saving mode) will be described. Transition to SLEEP mode is executed when a user's operation of the operation panel 24 and data reception of a facsimile or the like have not occurred for a predetermined period of time (e.g., one hour) during NORMAL mode. Transition to SLEEP mode is also executed when a user sets a power mode to a power saving mode during NORMAL mode.

At the time of transition to SLEEP mode, the main control unit 30 transmits information on a power mode to be transferred next to the sub control unit 37, and also transmits information on time when the power mode is transferred to the clock circuit unit 32 (S11). If a programmed job whose execution time is specified has been previously set by a user, the main control unit 30 sets information on transition to NORMAL mode to the sub control unit 37, and also sets information on the time specified for the programmed job to the clock circuit unit 32. Further, if a programmed job whose execution time is specified has not been set, the main control unit 30 sets information on transition to second power saving mode (OFF mode) to the sub control unit 37 and then sets the time information on the transition to second power saving mode (OFF mode) which has been previously set to the clock circuit unit 32.

The clock circuit unit 32 compares information on the time specified for the programmed job or time information on transition to OFF mode to the current time measured thereby, and determines whether the current time coincides with either one of the information on the specified time or the information on transition (S12).

If a determination that the current time has coincided with the specified time or the transition time (YES in S12), the clock circuit unit 32 transmits a transition instruction to the sub control unit 37 (S13).

If the determination that the current time has not coincided with the specified time or the transition time (NO in S12), mode transition processing is returned back to a step S12.

The sub control unit 37 determines whether the transition information set by the main control unit 30 is the information on transition to NORMAL mode or information on transition to second power saving mode (S14).

If the transition information set to the sub control unit 37 is the information on transition to NORMAL mode, the power mode is transferred from SLEEP mode to NORMAL mode, and the power mode transition processing is finished (S15).

If the transition information set to the sub control unit 37 is the information on transition to second power saving mode, the power mode is transferred from SLEEP mode to OFF mode, and the power mode transition processing is finished (S16).

Note that if the facsimile communication unit 39 detects a facsimile ringing signal during SLEEP or OFF mode, the sub control unit 37 controls the power mode to transfer from SLEEP or OFF mode to NORMAL mode. Consequently, power will be supplied to the main control unit 30.

Further, note that if a key operation signal is input by a user with the key operation unit 38 to the sub control unit 37 during SLEEP or OFF mode, the sub control unit controls the power mode to transfer from SLEEP or OFF mode to NORMAL mode.

More specifically, assume that the time of transition to OFF mode has been set to 10 p.m. on weekdays and the time of transition to NORMAL mode has been set to 8 a.m. on weekdays. In this case, if the power mode is in SLEEP mode, prior to transition to SLEEP mode, the main control unit 30 has already notified the sub control unit 37 of a power mode to be transferred next as transition information. For example, if the current time is 9 p.m., the main control unit 30 notifies the sub control unit 37 of the information on transition to the second power mode which has been previously set as a transition to be carried out next. Then, at 10 p.m. on weekdays, the clock circuit unit 32 transmits a transition instruction to the sub control unit 37, and the sub control unit 37, which received the transition instruction, controls to switch the power mode according to the transition instruction as a trigger for mode transition. At this time, as the sub control unit 37 controls to switch the power mode based on the information on transition to second power saving mode received from the main control unit 30, the power mode is transferred from SLEEP mode to OFF mode.

According to the image processing apparatus 100 in accordance with the preferred embodiments of the present invention, the period of time (e.g., holidays or night time) that network communication is not carried out has been previously set, and accordingly when the specified setting time arrives, the power mode is transferred from SLEEP mode to OFF mode whose power consumption is less than in SLEEP mode. Thus, electricity to the network control unit 33 that is not used during holidays or night time is turned off, which leads to reduction in power consumption.

Further, according to the image processing apparatus 100 in accordance with the preferred embodiments of the present invention, if a programmed job (e.g., sending a facsimile at a specified time) has been previously set, the power mode is transferred to NORMAL mode when the specified time has arrived, and accordingly the programmed job can be executed. Furthermore, if a facsimile ringing signal is received or a user performs a key operation using the key operation unit 38, the power mode can be returned from the second power saving mode to NORMAL mode. In this way, when the image processing apparatus 100 is requested to execute an operation, this request can be detected, and thus the power mode is automatically returned from OFF mode to NORMAL mode, which allows the image processing apparatus 100 to execute the operation at the appropriate timing. Thus, the power mode of the image processing apparatus 100 can be properly controlled, and it becomes possible to provide an image processing apparatus that provides both users' convenience and power saving effects.

Various preferred embodiments of the present invention can be realized as the above-described image processing apparatus, but also as a method for performing each operation of characteristic processing sections provided in the image processing apparatus. A preferred embodiment of the present invention can be also realized as an integrated circuit that performs the operations of each processing unit. A preferred embodiment of the present invention can be also realized as a program to execute the above described steps on a computer. Such programs can be loaded on storage media, such as a CD-ROM, or transmission mediums, such as the Internet.

The information processing system according to the present invention has been described based on the preferred embodiments of the present invention. However, the present invention is not limited to the above described preferred embodiments.

Various preferred embodiments of the present invention can achieve control of a power mode at an appropriate timing and can be adopted as an image processing apparatus increasing both user convenience and power saving effects.

While the present invention has been described with respect to preferred embodiments thereof, it will be apparent to those skilled in the art that the disclosed invention may be modified in numerous ways and may assume many preferred embodiments other than those specifically set out and described above. Accordingly, it is intended by the appended claims to cover all modifications of the present invention that fall within the true spirit and scope of the present invention.

What is claimed is:

1. An image processing apparatus comprising:
a network control unit connected to a network;
a main control unit arranged to control the network control unit;
a clock circuit unit arranged to store information on a specified time which has been previously set, to measure time, to compare time information stored in the clock circuit unit to time measured by the clock circuit unit, and to output a transition instruction, which is a trigger for power mode transition, according to a time comparison performed by the clock circuit unit;
a sub control unit arranged to store transition information on a power mode to be transferred next and to detect the transition instruction input from the clock circuit unit; and
a power mode switching unit arranged to switch the power mode from/to a first power saving mode in which power supply to the main control unit is stopped to/from a second power saving mode in which power supply to the main control unit and the network control unit is stopped; wherein
the main control unit transmits the transition information to the sub control unit at a time of transition to the first power saving mode;
the clock circuit unit transmits the transition instruction to the sub control unit upon determination, based on a time comparison, that the specified time in the information stored in the clock circuit unit has arrived; and
the sub control unit selectively controls the power mode switching unit to switch the power mode based on the transition information between transition from the first power saving mode to a normal mode and transition from the first power saving mode to the second power saving mode upon detection of the transition instruction during the first power saving mode.

2. The image processing apparatus according to claim 1, wherein
if a programmed job whose execution time is specified has been set, the main control unit sets information on transition to the normal mode and also sets information on a time specified for the programmed job to the clock circuit unit; and
if a programmed job whose execution time is specified has not been set, the main control unit sets information on transition to the second power saving mode to the sub control unit and then sets the information on transition to the second power saving mode, which has been set, to the clock circuit unit.

3. The image processing apparatus according to claim 1, further comprising:
a facsimile communication unit arranged to detect a facsimile ringing signal; wherein power is supplied to the facsimile communication unit in either of the first power saving mode or the second power saving mode, the sub control unit returns the power mode of the main control unit to the normal mode when the facsimile ringing signal detected by the facsimile communication unit is input to the sub control unit.

4. The image processing apparatus according to claim 1, further comprising:
a key operation unit to which power is supplied in either of the first power saving mode or the second power saving mode; wherein
the sub control unit returns the power mode of the main control unit to the normal mode when a key operation signal is input by a user to the sub control unit via the key operation unit.

5. An image processing method comprising the steps of:
transmitting transition information on a power mode of a main control unit to be transferred next to a sub control unit at a time of transition from a normal mode in which power is supplied to the main control unit to control a network control unit to a first power saving mode in which power supply to the main control unit is stopped;
storing the transition information in the sub control unit;
measuring time via a clock circuit unit;
transmitting a transition instruction which is a trigger for mode transition to the sub control unit when the clock circuit unit determines that a specified time has arrived by comparing information on a specified setting time stored in the clock circuit unit to time measured by the clock circuit unit; and
selectively controlling a power mode switching unit to switch the power mode based on the transition information between a transition from the first power saving mode to the normal mode and a transition from the first power saving mode to the second power saving mode in which power supply to the main control unit and the network control unit is stopped if the sub control unit detects the transition instruction during the first power saving mode.

6. The image processing method according to claim 5, wherein
in the step of transmitting the transition information, if a programmed job whose execution time is specified has been set, information on transition to the normal mode is set to the sub control unit, and information on a time specified for the programmed job is also set to the clock circuit unit; and
if a programmed job whose execution time is specified has not been set, information on transition to the second power saving mode is set to the sub control unit and then the information on a transition time to the second power saving mode which has been previously set is also set to the clock circuit unit.

7. The image processing method according to claim 5, further comprising the step of:
returning a power mode of the main control unit to the normal mode when a facsimile ringing signal is input to the sub control unit during either of the first power saving mode or the second power saving mode.

8. The image processing method according to claim 5, further comprising the step of:
returning the power mode of the main control unit to the normal mode when a key operation signal is input by a user via a key operation unit during either of the first power saving mode or the second power saving mode.
